(19) United States
(12) Patent Application Publication
(10) Pub. No.: US 2026/0035035 A1
(43) Pub. Date: Feb. 5, 2026

(54) BELT DRIVEN POSITION SENSOR

(71) Applicant: Steering Solutions IP Holding Corporation, Saginaw, MI (US)

(72) Inventors: Fred N. Golda, Bay City, MI (US); Ryan D. Harris, Clio, MI (US); David E. Harris, Birch Run, MI (US); Kevin M. McClendon, Frankenmuth, MI (US); William R. Root, Clio, MI (US)

(21) Appl. No.: 19/289,701

(22) Filed: Aug. 4, 2025

Related U.S. Application Data
(60) Provisional application No. 63/679,321, filed on Aug. 5, 2024.
(60) Provisional application No. 63/766,768, filed on Mar. 4, 2025.

(51) Int. Cl. B62D 15/02

(52) U.S. Cl. CPC B62D 15/0225

(57) ABSTRACT

A belt driven position sensor includes a ball screw. The belt driven position sensor also includes a belt operatively coupled to the ball screw, wherein the belt moves in response to translation of the ball screw. The belt driven position sensor further includes a plurality of pulleys, each of the plurality of pulleys being engaged with the belt, wherein the movement of the belt rotates each of the plurality of pulleys. The belt driven position sensor yet further includes a plurality of sensor magnets, at least one of the plurality of sensor magnets being at least partially embedded in each of the plurality of pulleys. The belt driven position sensor also includes a probe housing assembly having a plurality of sensor chips to determine an absolute position of the ball screw based on the angular position of each of the plurality of sensor magnets.

### CROSS-REFERENCE TO RELATED APPLICATIONS

This application claims the benefits of priority to U.S. Provisional Application Ser. No. 63/679,321, filed Aug. 5, 2024, and U.S. Provisional Application Ser. No. 63/766,768, filed Mar. 4, 2025, the disclosures of which are each incorporated by reference herein in their entireties.

### FIELD OF THE INVENTION

The embodiments described herein relate to vehicle steering systems and, more specifically, position sensors for such steering systems.

### BACKGROUND

Various electric power steering (EPS) systems have been developed for assisting an operator with vehicle steering. One type of EPS system is referred to as a rack electric power steering (REPS) system. A REPS system utilizes a pinion-driven position sensor to provide an absolute rack position to an electronic control unit (ECU). A gear mounted to the pinion shaft meshes with two gears within a probe housing. Each gear contains a magnet and has a different number of teeth, causing them to rotate at different ratios relative to the pinion. Sensor chips within the probe housing measure the angular positions of the magnets, and by combining these signals, a single non-repeating angular position signal for the pinion is generated. This signal, non-repeating over six pinion revolutions, is converted to rack position through the rack & pinion (R&P) gear ratio.

However, the transition to steer-by-wire (SbW) systems has eliminated the need for a mechanical connection between the handwheel and the rack, thereby removing the pinion shaft and rack teeth. Accordingly, a belt driven position sensor that may maintain the signal of the position sensor magnets without a pinion is needed.

### SUMMARY OF THE DISCLOSURE

According to one aspect of the disclosure, a belt driven position sensor includes a ball screw. The belt driven position sensor also includes a belt operatively coupled to the ball screw, wherein the belt moves in response to translation of the ball screw. The belt driven position sensor further includes a plurality of pulleys, each of the plurality of pulleys being engaged with the belt, wherein the movement of the belt rotates each of the plurality of pulleys. The belt driven position sensor yet further includes a plurality of sensor magnets, at least one of the plurality of sensor magnets being at least partially embedded in each of the plurality of pulleys. The belt driven position sensor also includes a circuit board including a plurality of sensor chips, the plurality of sensor chips being configured to detect an angular position of each of the plurality of sensor magnets. The circuit board determines an absolute position of the ball screw based on the angular position of each of the plurality of sensor magnets.

According to another aspect of the disclosure, a belt driven position sensor includes a ball screw. The belt driven position sensor also includes a belt operatively coupled to the ball screw, wherein the belt moves in response to translation of the ball screw. The belt driven position sensor further includes a plurality of pulleys, each of the plurality of pulleys being engaged with the belt, wherein the movement of the belt rotates each of the plurality of pulleys. The belt driven position sensor yet further includes a plurality of sensor magnets, at least one of the plurality of sensor magnets being at least partially embedded in each of the plurality of pulleys. The belt driven position sensor also includes a probe housing assembly having a plurality of sensor chips to determine an absolute position of the ball screw based on the angular position of each of the plurality of sensor magnets.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a perspective view of a belt driven position sensor of a vehicle steering system, according to one or more embodiments shown and described herein;

FIG. 2A is a bottom-side perspective view of a probe housing of the belt driven position sensor of FIG. 1, according to one or more embodiments shown and described herein;

FIG. 2B is a top-side perspective view of a probe housing of the belt driven position sensor of FIG. 1, according to one or more embodiments shown and described herein;

FIG. 2C is a top-side perspective view of a probe housing of the belt driven position sensor of FIG. 1, according to one or more embodiments shown and described herein;

FIG. 3A is a top-view of the belt driven position sensor of FIG. 1, according to one or more embodiments described herein;

FIG. 3B is a top view of a pulley system of the belt driven position sensor of FIG. 1, according to one or more embodiments shown and described herein.

FIG. 4 is a perspective view of a vehicle steering system including a belt driven position sensor, according to one or more embodiments shown and described herein;

FIG. 5A is a perspective view of an actuator housing of the belt driven position sensor, according to one or more embodiments shown and described herein;

FIG. 5B is a perspective view of the belt driven position sensor, according to one or more embodiments shown and described herein;

FIG. 5C is a perspective view of the belt driven position sensor, according to one or more embodiments shown and described herein;

FIG. 6A is a perspective view of a ball screw of the belt driven position sensor, according to one or more embodiments shown and described herein;

FIG. 6B is a perspective view of a belt driver of the belt driven position sensor, according to one or more embodiments shown and described herein;

FIG. 7 is an elevation view of a belt tensioner device according to one aspect of the disclosure; and

FIG. 8 is an elevation view of a belt tensioner device according to another aspect of the disclosure.

### DETAILED DESCRIPTION

Embodiments disclosed herein relate to a vehicle steering system and belt driven position sensor. In particular, the embodiments described herein are used in conjunction with a steering assembly of a vehicle, such as a car, truck, sport utility vehicle, crossover, mini-van, marine craft, aircraft, all-terrain vehicle, recreational vehicle, or other suitable vehicles, including various steering system schemes.

As noted hereinabove, traditional REPS systems use a pinion-driven position sensor to provide an absolute rack position signal to the electronic control unit (ECU). However, the transition to SbW technology has eliminated the need for a mechanical connection between a handwheel and a rack of traditional REPS, removing the pinion shaft and rack teeth. For example, a ball screw or a similar longitudinal member may be used.

The disclosed belt driven position sensor may utilize a ball screw for position sensing, as has been described herein. In these embodiments, the belt driven position sensor may drive the position sensor magnets, maintain the same number of magnet revolutions over the full ball screw travel to ensure the same position signal resolution, and provide a non-repeating absolute ball screw position signal. Furthermore, the disclosed belt driven position sensor may be implemented in SbW systems and eliminate the need for a pinion, thereby reducing mechanical complexity and potential failure points. For example, as will be described in additional detail herein, the belt driven position sensor may include a single-sided or a double-sided synchronous belt operatively coupled to a ball screw that translates. The belt converts ball screw translation to a corresponding sensor magnet rotational motion, such that the disclosed belt driven position system is able to accommodate dimensional tolerance stack-up while isolating the sensor magnets from rolling motion and bending deflection of the ball screw.

Embodiments of vehicle steering systems and belt driven position sensors will now be described in additional detail herein. The following will now describe these vehicle steering systems and belt driven position sensors in more detail with reference to the drawings and where like numbers refer to like structures.

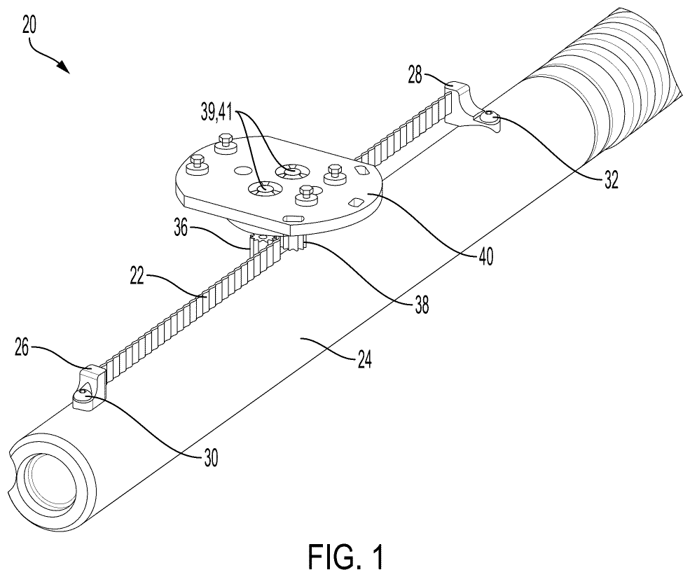

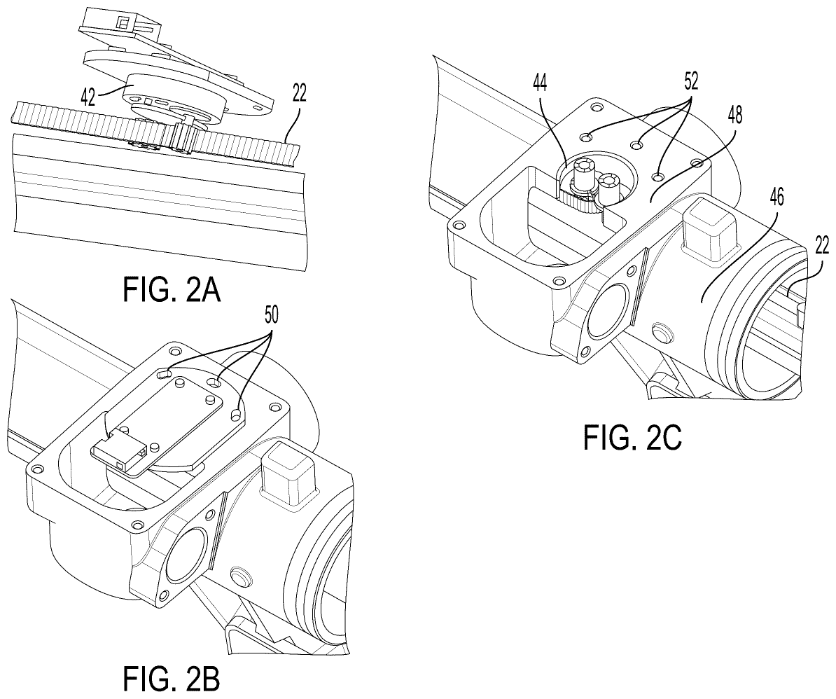

Referring now to FIGS. 1 and 2, a vehicle steering system and a belt driven position sensor 20 are depicted. As depicted most clearly in FIG. 2, a section of double-sided synchronous belt 22 may be positioned along ball screw 24 by one outboard belt anchor 26 and one inboard belt anchor 28. The belt anchors 26, 28 may be fastened to the ball screw 24 by belt anchor screws 30, 32. The anchors 26, 28 may engage the sides and bottom of shallow pockets machined into the ball screw 24 to provide good location and orientation control. The sides of the inboard anchor pocket may also react to a moment on the inboard anchor 28 resulting from the offset belt tension.

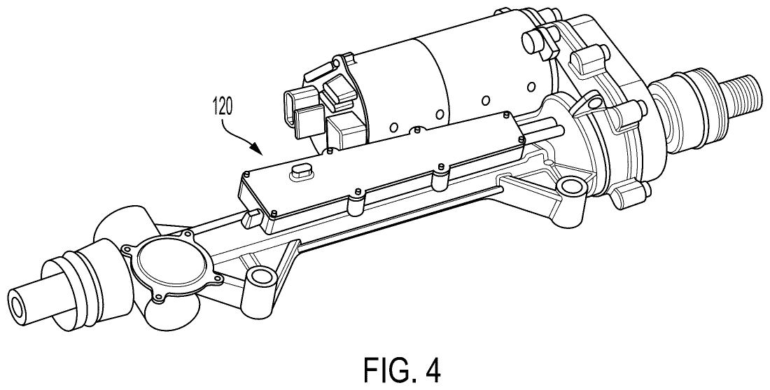

Referring still to FIGS. 1 and 2, the double-sided synchronous belt 22 may include drive teeth 34 on both sides (see FIGS. 4A and 4B). In these embodiments, one side of the belt 22 may be meshed with small sensor pulley 36 and the opposite side of the belt 22 may be meshed with large sensor pulley 38. Each pulley 36, 38 holds one sensor magnet 39, 41, respectively, such that each pulley and magnet rotate together. The pulleys 36, 38 are supported by a probe housing 40.

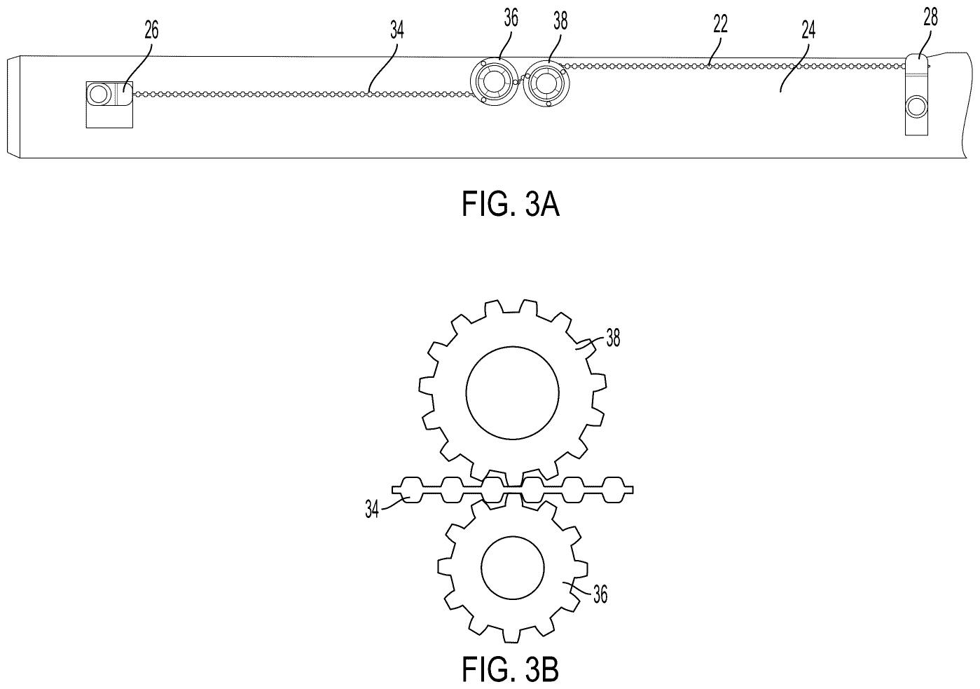

Referring now to FIGS. 3A-3C, a probe housing pilot 42 interfaces with a probe housing pilot diameter 44 in a ball screw housing 46. The cylindrical interface locates the probe housing 40 and pulleys 36, 38 relative to the belt 22, while allowing the probe housing 40 to rotate around the cylindrical interface axis. The probe housing 40 is further located by contact with probe housing mounting face 48. Probe housing 40 rotation relative to the ball screw housing 46 allows the belt 22 to remain slack as it is inserted between the pulleys 36, 38. The probe housing 40 is then rotated to remove the belt slack and is locked in place by screws inserted through slotted holes 50 and into probe housing mounting screw holes 52. The slotted holes accommodate variation in final probe housing rotational position when correct belt tension is achieved, this variation being a result of dimensional tolerance stack-up.

During steering maneuvers, the belt 22 translates with the ball screw 24 and causes both pulleys 36, 38 to rotate. The magnets 39, 41 rotate with the pulleys 36, 38 and their angular position is measured by sensor chips within the probe housing assembly. The two pulleys 36, 38 have different numbers of teeth and therefore rotate at different ratios relative to the belt 22. The two angular position signals are combined to create a single non-repeating ball screw position signal. The position signal does not repeat over full ball screw travel and is therefore absolute.

Referring now to FIGS. 4A and 4B, the belt 22 is depicted as routing from the outboard anchor 26, around and between the pulleys 36, 38, and to the inboard belt anchor 28. Due to the belt wrap around the pulleys 36, 38, the belt 22 enters the pulleys 36, 38 in different planes on the inboard and outboard sides. The inboard anchor 28 is offset from the outboard anchor 26 to accommodate this belt placement. If the belt anchors 26, 28 were inline, an angle would be created between the belt 22 and ball screw axis. This angle would change with ball screw 24 travel potentially causing position signal error.

To maintain the same number of magnet rotations as the pinion driven REPS position sensor, small pitch diameter pulleys are needed. A belt drive facilitates the required small diameter because of the ability of the belt 22 to wrap around the pulley and have multiple teeth engaged. Having multiple teeth engaged is important to provide a lash-free belt to pulley interface, as lash is a source of position signal error. In contrast, if a rack and pinion gear mesh were used in place of the belt and pulleys, the small pinion gear pitch diameter would require very small teeth to maintain multiple teeth in contact and a lash-free interface. Such a design may not be manufacturable.

Due to dimensional tolerance stack-up of all the components in the RWA assembly, there may be variation in the alignment of the ball screw 24 and pulleys 36, 38. The ball screw 24 to pulley 36, 38 alignment may also be affected by rolling and bending of the ball screw 24 during steering maneuvers. The natural flexibility of the belt 22 will accommodate alignment deviations between the pulleys 36, 38 and ball screw 24 and isolate the pulleys 36, 38 from rolling and bending motion of the ball screw 24. The isolation will reduce position signal error from ball screw rolling and bending.

As depicted most clearly in FIG. 4B, it should be appreciated that the gap between the pulley outside diameters can be designed such that the belt 22 and pulley cannot separate enough for the teeth to disengage. This provides redundancy for positive tooth engagement in the event belt tension is momentarily lost.

In view of the foregoing, it should be appreciated that the embodiments described herein are related to a vehicle steering system and a belt driven position sensor. The belt driven position sensor eliminates the need for a pinion, thereby reducing the mechanical complexity of the sensor and potential failure points. Furthermore, the belt driven position sensor may utilize a synchronous belt to transfer ball screw translating motion to sensor magnet rotational motion and to accommodate dimensional tolerance stack-up between the ball screw and sensor magnets. The synchronous belt may further isolate sensor magnets from ball screw rolling motion and bending deflection. As described herein, the belt driven position sensor may further include a probe housing assembly with attached pulleys which rotates around an axis to adjust belt tension. An offset belt anchor maintains the belt parallel to a ball screw axis while allowing the belt to wrap around pulleys. In these embodiments, the pulley to pulley center distance may be configured to prevent belt to pulley tooth disengagement, while the pulley diameters may be sized to maximize ball screw position signal resolution while maintaining a non-repeating position signal.

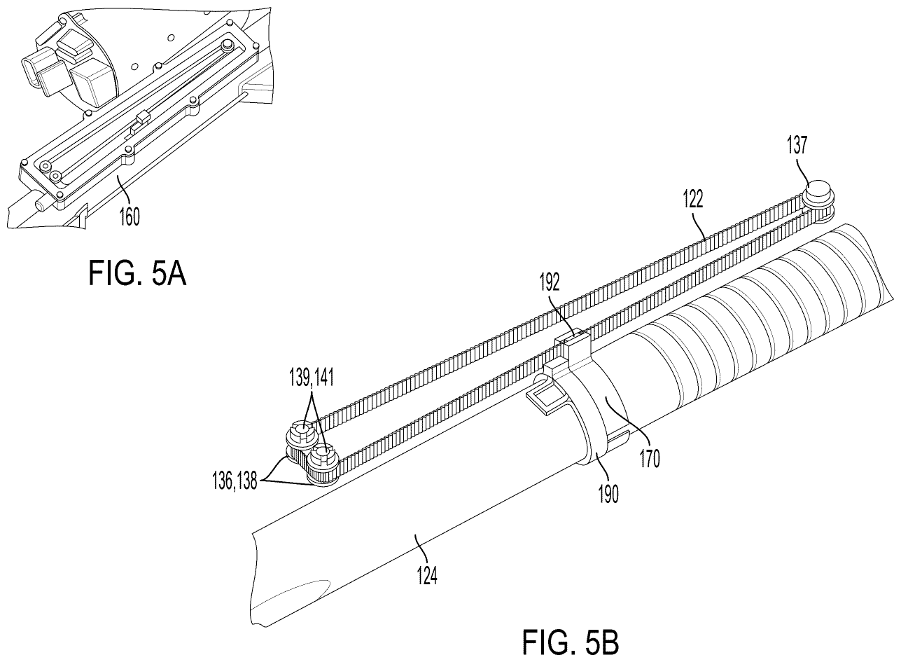

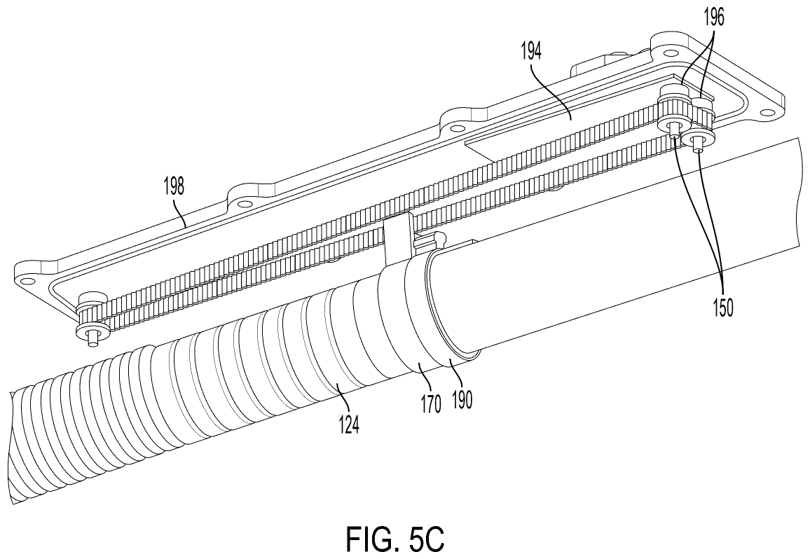

FIGS. 5-7B illustrate another embodiment of the belt driven position sensor, which is generally referenced herein with 120.

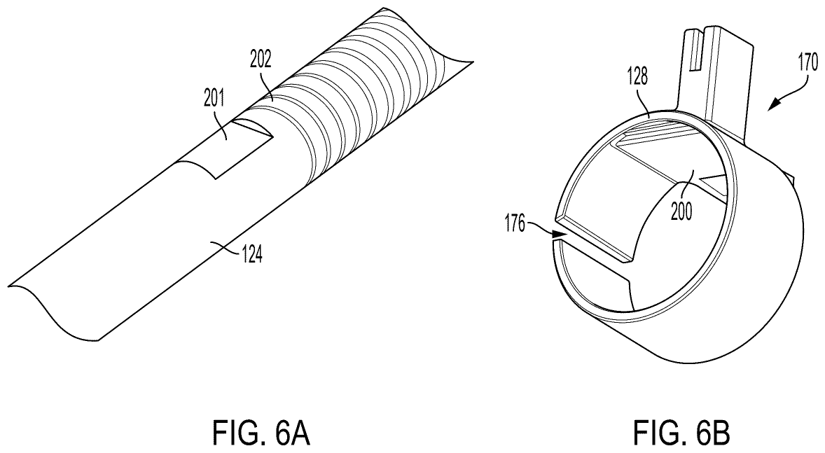

Referring now to FIGS. 5 and 6A-6C, the belt driven position sensor may include a belt 122, such as a continuous single-sided synchronous belt 122 that may be configured to wrap around and mesh with a plurality of sensor pulleys 136, 138 and at least one idler pulley 137. Although the belt driven position sensor 120 depicted in FIGS. 5 and 6A-6C includes two sensor pulleys 136, 138 and a single idler pulley 137, it should be appreciated that the belt driven position sensor 120 may include any number of pulleys (e.g., pulleys 136, 138 and idler pulley 137) without departing from the scope of the present disclosure.

As shown, each of the plurality of pulleys 136, 138 may contain a sensor magnet 139, 141, respectively. For example, in these embodiments, a sensor magnet may be embedded in each of the plurality of pulleys 136, 138, such that the sensor magnets embedded within each of the plurality of pulleys 136, 138 generate a magnetic field. In operation, as the belt 122 moves, the rotation of the plurality of pulleys 136, 138 similarly results in rotation of each of the sensor magnets. As the sensor magnets 139, 141 rotate, the magnetic field generated by the sensor magnets may change, with the variation in the magnetic field being used to determine angular measurements of the plurality of pulleys 136, 138, and, in turn, a position of a ball screw 124 of the belt driven position sensor, as will be described in additional detail herein.

Referring still to FIGS. 5 and 6A-6C, the plurality of pulleys 136, 138 and the idler pulley 137 are each rotatable relative to dowel pins 150. In these embodiments, the dowel pins 150 are positioned on an actuator housing 160 of the belt driven position sensor 120 by press fitting the dowel pins 150 into corresponding holes formed within the actuator housing 160. As depicted most clearly in FIG. 6B, a plastic belt driver 170 is secured over and/or about an outer diameter of the ball screw 124 and is securely held in place by a retention clamp 190. In these embodiments, the clamp 190 can be a common car clamp as used for retaining steering gear boots, or any other similar clamp without departing from the scope of the present disclosure.

As further illustrated in FIG. 6B, a metal crimp ring 192 may be crimped securely onto the belt 122, such that the crimp ring 192 fits into a pocket in the belt driver 170. In these embodiments, the crimp ring 192 to pocket interface is designed to be lash free. An integral tab may extend to the side of the metal crimp ring 192 parallel to the belt 122. After the ring 192 is secured to the belt 122 by crimping, the tab may be bent towards the belt 122 such that it increases belt tension. This allows the belt tension to be adjusted on each assembly. A circuit board 194 containing sensor chips 196 is assembled to the sensor cover 198. The sensor cover 198 may be secured to the actuator housing to enclose the sensor cavity and position the sensor chips 196 over the sensor magnets 139, 141 embedded within the pulleys 136, 138.

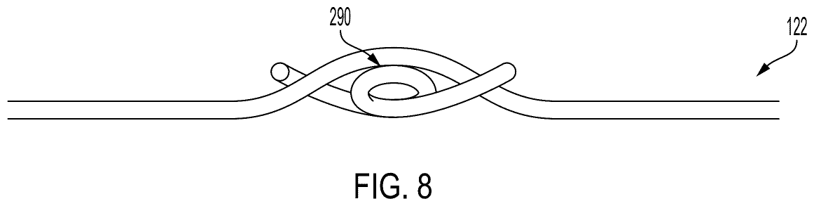

In some cases, due to geometric tolerance, it may be necessary to adjust belt tension to reduce belt slack and tune system friction. Two additional embodiments of belt tensioning devices are shown in FIGS. 8 and 9. These devices are attached to the belt 122 near the location of the belt driver so as not to interfere with the operation of the pulleys. The first embodiment includes a plastic bracket 270 and a threaded fastener 280 (FIG. 8). As the fastener 280 is advanced it acts on the belt 122 and increases belt tension. The second embodiment includes of a helical spring 290 with arms that extend beyond the main body and then turn 90 degrees as to be parallel but offset to the main axis of the helix (FIG. 9). The spring 290 is slipped over the belt 122 such that when the spring tension in the arms is released it acts on the belt 122 and increases belt tension.

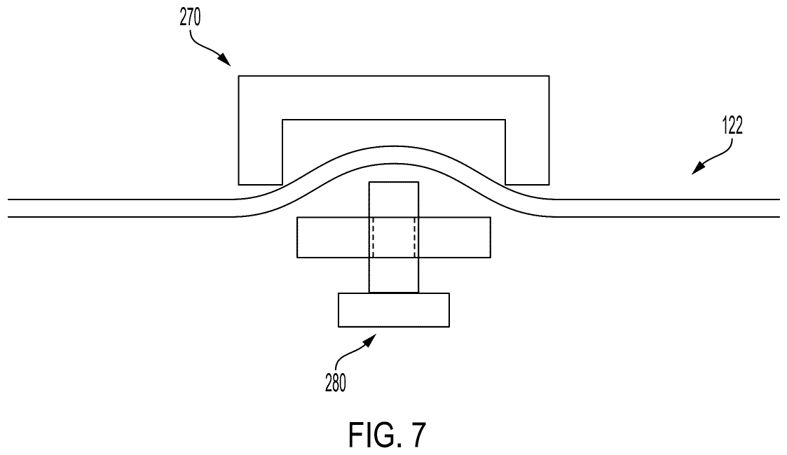

Turning now to FIGS. 7A and 7B, a flat 201 is milled into a cylindrical center section of the ball screw 124. As provided herein, the term “flat” may refer to a machined (e.g., milled or otherwise) flat surface formed on an otherwise cylindrical section of the ball screw 124. Furthermore, as provided herein, the formation of the flat 201 may further result in the formation of a shoulder 202, which provides a barrier between the flat 201 and the cylindrical section of the ball screw 124.

As depicted most clearly in FIG. 7B, the belt driver 170 may further include a belt driver flat 200 that engages the ball screw flat 201, which ensures that the belt driver 170 and the ball screw 124 cannot rotate independently of one another. In these embodiments, the belt driver 170 further includes a split 176 that allows the belt driver ring to expand as it is assembled over the ball screw 124. As the belt driver flat 200 engages the ball screw flat, the flexible ring collapses to closely fit the ball screw diameter. The flat-to-flat interface rotationally orients the belt driver 170 on the ball screw 124. The belt driver face 128 mates with the ball screw shoulder 202 and axially locates the belt driver 170 on the ball screw 124.

Operation of the belt driven position sensor 120 will now be described in detail herein with reference to FIGS. 5-7B. For example, during steering maneuvers, the belt 122 may translate with the ball screw 124 and causes the sensor pulleys 136, 138 to rotate. The magnets 139, 141 may rotate with the pulleys 136, 138 and the angular position of each of the pulleys may be measured by sensor chips on the circuit board 194. In these embodiments, each of the plurality of pulleys 136, 138 may have different numbers of teeth, such that each of the plurality of pulleys rotates at a different ratio relative to the belt translation. As with the REPS pinion driven position sensor, the angular position signals of the plurality of pulleys 136, 138 are combined to create a single non-repeating ball screw position signal. The position signal does not repeat over full ball screw travel, thereby providing an absolute position signal.

To maintain the same number of magnet rotations as the pinion driven REPS position sensor, small pitch diameter pulleys may be utilized. In these embodiments, the belt drive may facilitate the small diameter pulleys because of the ability of the belt 122 to wrap around the pulley and have multiple teeth engaged. It should be further appreciated that having multiple teeth of each of the plurality of pulleys 136, 138 engaged may aid in providing a lash-free belt to pulley interface, as lash may be a source of position signal error.

Due to dimensional tolerance stack-up of all the components in the RWA assembly, it should be further appreciated that variation may exist in the alignment of the ball screw 124 and pulleys. Furthermore, alignment may be affected by rolling and bending of the ball screw 124 during steering maneuvers. However, in the embodiments described herein, the natural flexibility of the belt 122 may accommodate alignment deviations between the pulleys and ball screw 124 and isolate the pulleys from the rolling and bending motion of the ball screw 124. Accordingly, the isolation may reduce position signal error from ball screw rolling and bending.

In view of the foregoing, it should be appreciated that the embodiments described herein are related to a vehicle steering system and a belt driven position sensor. The belt driven position sensor eliminates the need for a pinion, thereby reducing the mechanical complexity of the sensor and potential failure points. Furthermore, the belt driven position sensor may utilize a synchronous belt to transfer ball screw translating motion to sensor magnet rotational motion. In the embodiments described herein, the flexible belt may accommodate dimensional tolerance stack-up between the ball screw and sensor magnets while also isolating the sensor magnets from ball screw rolling motion and bending deflection. The belt driven position sensor may further include a belt driver designed with a split to allow for expansion over the ball screw during assembly, and a retention clamp to ensure the belt driver always remains engaged to a ball screw flat. In these embodiments, the retention clamp may generate a normal force between the belt driver and ball screw. The normal force generating friction between the belt driver and ball screw may be sufficient to resist belt loading and therefore providing to a lash free joint. As further provided herein, the belt driven position sensor may also include a crimp ring attached to the synchronous belt that provides a means of engagement to the belt driver. A pocket may also be formed in the belt driver (e.g., which is smaller than the crimp ring) and designed to flex as the crimp ring is inserted, thereby providing a lash free interface. The plurality of pulleys of the belt driven position sensor may also utilize press fit dowel pins to locate the pulleys in the actuator housing.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A belt driven position sensor comprising:
a ball screw;
a belt operatively coupled to the ball screw, wherein the belt moves in response to translation of the ball screw;
a plurality of pulleys, each of the plurality of pulleys being engaged with the belt, wherein the movement of the belt rotates each of the plurality of pulleys;
a plurality of sensor magnets, at least one of the plurality of sensor magnets being at least partially embedded in each of the plurality of pulleys;
a circuit board including a plurality of sensor chips, the plurality of sensor chips being configured to detect an angular position of each of the plurality of sensor magnets;
wherein the circuit board determines an absolute position of the ball screw based on the angular position of each of the plurality of sensor magnets.

2. The belt driven position sensor of claim 1, further comprising a belt driver surrounding an outer diameter of the ball screw.

3. The belt driven position sensor of claim 2, wherein the belt driver is secured to the outer diameter of the ball screw with a retention clamp.

4. The belt driven position sensor of claim 2, wherein the belt driver is formed of plastic.

5. The belt driven position sensor of claim 2, further comprising a crimp ring secured to the belt, wherein the crimp ring is disposed within a pocket defined by the belt driver.

6. The belt driven position sensor of claim 5, wherein the crimp ring is formed of metal.

7. The belt driven position sensor of claim 2, wherein the belt driver includes a flat on a radially inner surface which engages a ball screw flat formed on an outer surface of the ball screw to prevent relative rotation between the belt driver and the ball screw.

8. The belt driven position sensor of claim 2, wherein the belt driver defines a split to allow the belt driver to expand as it is assembled over the ball screw.

9. The belt driven position sensor of claim 1, wherein the plurality of pulleys includes a first sensor pulley, a second sensor pulley and an idler pulley.

10. The belt driven position sensor of claim 1, wherein the belt has a plurality of teeth on a single side of the belt, wherein the plurality of teeth are engaged with the plurality of pulleys.

11. A belt driven position sensor comprising:
a ball screw;
a belt operatively coupled to the ball screw, wherein the belt moves in response to translation of the ball screw;
a plurality of pulleys, each of the plurality of pulleys being engaged with the belt, wherein the movement of the belt rotates each of the plurality of pulleys;
a plurality of sensor magnets, at least one of the plurality of sensor magnets being at least partially embedded in each of the plurality of pulleys; and
a probe housing assembly having a plurality of sensor chips to determine an absolute position of the ball screw based on the angular position of each of the plurality of sensor magnets.

12. The belt driven position sensor of claim 11, wherein the belt has a plurality of teeth on both sides of the belt, the teeth engaged with the plurality of pulleys.

13. The belt driven position sensor of claim 11, wherein the belt has a plurality of teeth on a single side of the belt, the teeth engaged with the plurality of pulleys.

14. The belt driven position sensor of claim 11, wherein the belt is fixed at a first end of the belt to an outboard anchor operatively coupled to the ball screw, wherein the belt is fixed at a second end of the belt to an inboard anchor operatively coupled to the ball screw.

15. The belt driven position sensor of claim 14, wherein the inboard anchor and the outboard anchor are positioned to have a first portion of the belt and a second portion of the belt parallel but offset with each other along the ball screw.

16. The belt driven position sensor of claim 11, wherein the probe housing assembly has the plurality of pulleys operatively coupled thereto, the plurality of pulleys rotatable around an axis to adjust belt tension.

17. The belt driven position sensor of claim 16, wherein each of the pulleys are located relative to the probe housing assembly with at least one press fit dowel pin.

18. The belt driven position sensor of claim 11, wherein each of the plurality of pulleys have a respective diameter sized to maximize ball screw position signal resolution and maintain a non-repeating position signal.
